(19) United States
(12) Patent Application Publication
(10) Pub. No.: US 2012/0295105 A1
(43) Pub. Date: Nov. 22, 2012

(54) SURFACE-PROTECTION FILM, MANUFACTURING METHOD THEREFOR, BASE FILM FOR A SURFACE-PROTECTION FILM, AND MANUFACTURING METHOD THEREFOR

(75) Inventors: Yoichiro Kimura, Sanbu-gun (JP); Tomoyuki Kitajima, Sanbu-gun (JP)

(73) Assignee: IDEMITSU UNITECH CO., LTD., Tokyo (JP)

(21) Appl. No.: 13/522,722

(22) PCT Filed: Dec. 24, 2010
(86) PCT No.: PCT/JP2010/073316

§ 371 Date: Jul. 18, 2012

(30) Foreign Application Priority Data
Jan. 18, 2010 (JP) 2010-008070

(51) Int. Cl. B29C 71/02; C09J 7/02; B32B 7/12; B32B 37/06

(52) U.S. Cl. 428/354; 156/60; 428/343; 432/18

(57) ABSTRACT

A surface protective film includes a base layer having polyolefin as a main component and an adhesion layer. The surface protective film and a base film for the surface protective film are thermally treated at a temperature from 40 degrees C. to 100 degrees C. for 1 second to 120 seconds and a size change ratio at which each of the surface protective film and the base film changes in size after being heated at 90 degrees C. for one hour falls within ±0.50% in each of MD (a machine direction) and TD (a traverse direction). Generation of curling is prevented and a surface of a target member is protected without damaging properties or performance of the target member.

### TECHNICAL FIELD

The present invention relates to a surface protective film including a base layer and an adhesion layer, a manufacturing method therefor, a base film for the surface protective film serving as the base layer of the surface protective film, and manufacturing method therefor.

### BACKGROUND ART

There has been known a surface protective film that is temporarily attached to a surface of a metal plate, a glass plate or a synthetic resin plate for preventing the surface from being damaged or being attached with dust (see, for instance, Patent Literature 1).

The surface protective film disclosed in Patent Literature 1 includes a base layer and an adhesion layer. The base layer is a typically usable polyolefin support in a form of a sheet or a film. The adhesion layer contains a styrene elastomer, a polyolefin and a tackifier. The styrene elastomer contains a non-hydrogenated or hydrogenated vinyl-polyisoprene block.

### CITATION LIST

### Patent Literature(s)

Patent Literature 1: JP-A-2008-297430

### SUMMARY OF THE INVENTION

### Problems to be Solved by the Invention

Currently, the surface protective film is used for preventing a member used in a liquid crystal monitor or the like from being made dirty or damaged. However, since curling is generated by shrinkage of the surface protective film after the surface protective film is adhered to a member at a member manufacturing site, the member is curled, so that an operating efficiency and a yield rate are decreased to increase manufacturing costs. Recently, the above problem becomes more apparent since the member becomes thinner.

In the conventional art, the surface protective film considerably changes in size due to insufficient treatment of removing residual stress of the surface protective film. Accordingly, after the surface protective film is adhered, the surface protective film shrinks to generate curling, so that the member is curled.

In view of the above, an object of the invention is to provide a surface protective film capable of preventing a target member, to which the surface protective film is adhered, from being curled, a manufacturing method therefor, a base film for the surface protective film, and a manufacturing method therefor.

### Means for Solving the Problems

A surface protective film according to an aspect of the invention and a method for the manufacturing the surface protective film according to another aspect of the invention includes a base layer and an adhesion layer, in which polypropylene is used as a main component for the base layer, and before or after the adhesion layer is laminated on the base layer, the surface protective film is thermally treated at a temperature from 40 degrees C. to 100 degrees C. for 1 second to 120 seconds such that a size change ratio at which the surface protective film changes in size after being heated at 90 degrees C. for one hour falls within ±0.50% in each of MD (a machine direction) and TD (a traverse direction).

A base film for a surface protective film according to a still another aspect of the invention and a method for the manufacturing the base film according to a further aspect of the invention includes a base film on which an adhesion layer is laminated, in which polypropylene is used as a main component, and the base film is thermally treated at a temperature from 40 degrees C. to 100 degrees C. for 1 second to 120 seconds such that a size change ratio at which the surface protective film changes in size after being heated at 90 degrees C. for one hour falls within ±0.50% in each of MD (a machine direction) and TD (a traverse direction).

In the surface protective film manufactured according to the above aspect of the invention and the surface protective film obtained by using the base film for the surface protective film according to the above aspect of the invention, the size change ratio at which the surface protective film changes in size after being heated at 90 degrees C. for one hour falls within ±0.50% in each of MD (a machine direction) and TD (a traverse direction), thereby preventing generation of curling caused by shrinkage of the surface protective film after the surface protective film is adhered to a target member.

### DESCRIPTION OF EMBODIMENT(S)

An exemplary embodiment of the invention will be described below. Arrangement of Surface Protective Film

A surface protective film of the exemplary embodiment includes a base layer and an adhesion layer.

Arrangement of Base Layer of Surface Protective Film

The base layer serves as a support of the surface protective film and is a base film in a form of a sheet or a film containing polypropylene as a main component.

As polypropylene usable as the base layer, for instance, a homopolymer, a random copolymer, a block copolymer or the like is singularly usable, or a combination thereof is usable as needed. Particularly, in the base layer containing a block copolymer, a surface of the base layer is roughened and thus unwinding property is improved while tearing strength and impact strength are also improved. The block copolymer is preferably used because the block copolymer provides heat resistance and rigidity. The base layer only needs to contain polypropylene of more than 50 mass %. The base layer may also contain a mixture of various polyolefins. Examples of the polyolefins to be mixed include low-density polyethylene, medium-density polyethylene, high-density polyethylene, linear low-density polyethylene, an ethylene-alpha-olefin copolymer, an ethylene-vinyl-acetate copolymer, an ethylene-ethylacrylate copolymer, an ethylene-methyl methacrylate copolymer and an ethylene-n-butyl acrylate copolymer.

It should be noted that the base layer may contain additives such as a pigment, an antioxidant, a stabilizer and an ultraviolet absorber as needed.

The base layer may be formed by a plurality of layers. The total thickness of the base layer formed of a single layer or a plurality of layers is preferably in a range of 10 μm to 80 μm. When the thickness of the base layer is less than 10 μm, rigidity of the surface protective film is decreased, so that operations of attaching/peeling the surface protective film to/from the target member may become complicated, or the surface protective film may be stretched by a tension applied when the surface protective film is unwound. On the other hand, when the thickness of the base layer exceeds 80 μm, although a surface protection performance of the base layer to the target member is not changed, manufacturing costs may be raised due to increase in a material used for manufacturing the surface protective film.

### Arrangement of Adhesion Layer

As the adhesion layer, various adhesives such as acrylic adhesives, rubber adhesives and synthetic rubber adhesives are usable. One of the above resins may be used alone or any combination thereof may be used as a mixture. The adhesion layer can contain a tackifier, a plasticizer, a filler, an antioxidant, an ultraviolet absorber, a silane coupler and the like as needed.

The thickness of the adhesion layer is in a range of 1 μm to 25 μm. When the thickness of the adhesion layer is less than 1 μm, for instance, if the target member has a projection, a tip of the projection may be damaged, or an adhesion strength of the adhesion layer may be decreased so that the adhesion layer may peel off the target member. On the other hand, when the thickness of the adhesion layer is more than 25 μm, the adhesion strength becomes too strong, so that adhesive residue may be generated in peeling. Also, since the adhesion strength with a rear surface of the base layer is increased, unwinding property from a roll product may be reduced.

### Arrangement of Base Film for Surface Protective Film

A base film for a surface protective film of the exemplary embodiment contains polypropylene as a main component.

The base film for the surface protective film serves as a support of the surface protective film and contains polypropylene as a main component.

As polypropylene usable as the base film for the surface protective film, for instance, a homopolymer, a random polymer, a block copolymer or the like is singularly usable, or a combination thereof is usable as needed. Particularly, in the base film for the surface protective film containing a block copolymer, a surface of the base layer is roughened and thus unwinding property is improved while tearing strength and impact strength are also improved. The block copolymer is preferably used because the block copolymer provides heat resistance and rigidity. The base film for the surface protective film only needs to contain polypropylene of more than 50 mass %. The base film for the surface protective film may also contain a mixture of various polyolefins. Examples of the mixed polyolefins include low-density polyethylene, medium-density polyethylene, high-density polyethylene, linear low-density polyethylene, an ethylene-alpha-olefin copolymer, an ethylene-vinyl-acetate copolymer, an ethylene-ethylacrylate copolymer, an ethylene-methyl methacrylate copolymer and an ethylene-n-butyl acrylate copolymer.

It should be noted that the base film for the surface protective film may contain additives such as a pigment, an antioxidant, a stabilizer and an ultraviolet absorber as needed.

The base film for the surface protective film may be formed by a plurality of layers. The total thickness of the base film for the surface protective film formed of a single layer or a plurality of layers is preferably in a range of 10 μm to 80 μm. When the thickness of the base film for the surface protective film is less than 10 μm, rigidity of the surface protective film is decreased, so that operations of attaching/peeling the surface protective film to/from the target member may become complicated, or the surface protective film may be stretched by a tension applied when the surface protective film is unwound. On the other hand, when the thickness of the base film for the surface protective film exceeds 80 μm, although a surface protection performance of the base film for the surface protective film to the target member is not changed, manufacturing costs may be raised due to increase in a material used for manufacturing the surface protective film.

### Manufacturing Method of Surface Protective Film

For manufacturing the surface protective film, a method of laminating the adhesion layer onto the base layer is not particularly limited, but any method is applicable. Particularly, co-extrusion for lamination is preferable in terms of cost-saving by a simplified manufacturing procedure, a large interlaminar strength between the base layer and the adhesion layer, and the like.

The surface protective film is thermally treated at a temperature from 40 degrees C. to 100 degrees C. for 1 second to 120 seconds before or after the adhesion layer is laminated on the base layer. The exemplary embodiment exemplifies thermal treatment of the surface protective film at a temperature from 40 degrees C. to 100 degrees C. for 1 second to 120 seconds, the surface protective film being provided by laminating the adhesion layer onto the base layer by co-extrusion. The thus formed surface protective film may be further thermally treated.

When the thermal treatment is conducted at more than 100 degrees C., even in a short time of about one second, the base layer becomes melted or excessively shrunken by heat. On the other hand, when the thermal treatment is conducted at less than 40 degrees C., time for thermal treatment becomes longer than 120 seconds and the thermal treatment is less likely to provide a sufficient effect, so that productivity of the surface protective film is decreased.

By this thermal treatment, a size change ratio at which the base film changes in size after being heated at 90 degrees C. for one hour falls within ±0.50% in each of MD (a machine direction) and TD (a traverse direction). The manufactured surface protective film is adhered to the target member.

### Manufacturing Method of Base Film for Surface Protective Film

In addition to the thermal treatment of the surface protective film, the base film for the surface protective film (i.e., the base layer before the adhesion layer is laminated thereon) may be thermally treated and then the adhesion layer may be laminated on the base film, thereby forming the surface protective film.

Specifically, the base film for the surface protective film is thermally treated at a temperature from 40 degrees C. to 100 degrees C. for 1 second to 120 seconds in manufacturing. The exemplary embodiment exemplifies a thermal treatment procedure of the base film for the surface protective film at a temperature from 40 degrees C. to 100 degrees C. for 1 second to 120 seconds, the base film being formed by a T-die cast method.

When the thermal treatment is conducted at more than 100 degrees C., even in a short time of about one second, the base film for the surface protective film becomes melted or excessively shrunken by heat. On the other hand, when the thermal treatment is conducted at less than 40 degrees C., time for thermal treatment becomes longer than 120 seconds and the thermal treatment is less likely to provide a sufficient effect, so that productivity of the base film is decreased.

By this thermal treatment, a size change ratio at which the base film changes in size after being heated at 90 degrees C. for one hour falls within ±0.50% in each of MD (a machine direction) and TD (a traverse direction).

An adhesion layer is laminated on the manufactured base film for the surface protective film, which is adhered to the target member.

### Advantages of Exemplary Embodiment

In the exemplary embodiment, as described above, the surface protective film in which the adhesion layer is provided on the base layer and the base film for the surface protective film are thermally treated at a temperature from 40 degrees C. to 100 degrees C. for 1 second to 120 seconds and a size change ratio at which each of the surface protective film and the base film changes in size after being heated at 90 degrees C. for one hour falls within ±0.50% in each of MD (a machine direction) and TD (a traverse direction).

The above feature prevents generation of curling and makes it possible to favorably protect a surface of the target member without damaging properties of the target member even when the surface protective film is adhered to a relatively thin prism sheet.

In the exemplary embodiment, the surface protective film in which the adhesion layer is laminated on the base layer by co-extrusion is thermally treated.

Accordingly, even in the surface protective film efficiently manufactured by co-extrusion, residual stress is fully relaxed to prevent generation of curling even when the surface protective film is adhered to the target member

### Modifications

It should be noted that the invention is not limited to the above exemplary embodiment but may include any modification and improvement as long as such modification and improvement are compatible with the invention.

### EXAMPLES

The invention will further be described below with reference to Examples and Comparatives.

It should be noted that the invention is not limited to Examples.

### Preparation of Samples

### Example 1

A styrene elastomer (manufactured by KURARAY CO., LTD., product name: HYBRAR 7311) as an adhesion layer and block polypropylene (BPP) (manufactured by SunAllomer Ltd., product name: PC-684S) as a polypropylene base layer were co-extruded by double-layer co-extrusion such that a thickness of the adhesion layer was 11 μm and a thickness of the base layer was 39 μm, and were thermally treated at 70 degrees C. for five seconds, so that a sample of Example 1 was obtained.

### Example 2

A styrene elastomer (manufactured by KURARAY CO., LTD., product name: HYBRAR 7311) as the adhesion layer and BPP (manufactured by SunAllomer Ltd., product name: PC-684S) as the polypropylene base layer were co-extruded by double-layer co-extrusion such that a thickness of the adhesion layer was 11 μm and a thickness of the base layer was 39 and were thermally treated at 50 degrees C. for 60 seconds, so that a sample of Example 2 was obtained.

### Example 3

A 39-μm thick base film formed of BPP (manufactured by SunAllomer Ltd., product name: PC-684S) was thermally treated at 90 degrees C. for three seconds. On a surface of the base film, a styrene elastomer composition (manufactured by KURARAY CO., LTD., product name: HYBRAR 7311) was coated as the adhesion layer and dried such that a thickness of the dried adhesion layer was 11 μm, so that a sample of Example 3 was obtained.

### Comparative 1

The adhesion layer and the base layer were co-extruded by double-layer co-extrusion in the same layer arrangement and thickness as those in Example 1 but were not thermally treated, so that a sample of Comparative 1 was obtained.

### Comparative 2

The adhesion layer and the base layer were co-extruded by double-layer co-extrusion in the same layer arrangement and thickness as those in Example 1 and were thermally treated at 30 degrees C. for 60 seconds, so that a sample of Comparative 2 was obtained.

### Comparative 3

The adhesion layer and the base layer were co-extruded by double-layer co-extrusion in the same layer arrangement and thickness as those in Example 1 and were thermally treated at 60 degrees C. for 0.5 second, so that a sample of Comparative 3 was obtained.

### Comparative 4

The adhesion layer and the base layer were co-extruded by double-layer co-extrusion in the same layer arrangement and thickness as those in Example 1 and were thermally treated at 150 degrees C. for 60 seconds, so that a sample of Comparative 4 was obtained.

### Comparative 5

A styrene elastomer (manufactured by KURARAY CO., LTD., product name: HYBRAR 7311) as the adhesion layer and a mixture of 40 mass % of BPP (manufactured by SunAllomer Ltd., product name: PC-684S) and 60 mass % of metallocene linear low-density polyethylene (density: 891 kg/m³, MFR: 4.2 g/10 min) as the base layer were co-extruded by double-layer co-extrusion such that a thickness of the adhesion layer was 11 μm and a thickness of the base layer was 39 μm, and were thermally treated at 70 degrees C. for five seconds, so that a sample of Comparative 5 was obtained.

### Comparative 6

A styrene elastomer (manufactured by KURARAY CO., LTD., product name: HYBRAR 7311) as the adhesion layer and a mixture of 40 mass % of BPP (manufactured by SunAllomer Ltd., product name: PC-684S) and 60 mass % of metallocene linear low-density polyethylene (density: 891 kg/m³, MFR: 4.2 g/10 min) as the base layer were co-extruded by double-layer co-extrusion such that a thickness of the adhesion layer was 11 μm and a thickness of the base layer was 39 μm, and were thermally treated at 50 degrees C. for 60 seconds, so that a sample of Comparative 6 was obtained.

### Comparative 7

A prism base sheet (140 μm thick) having a triangular cross-section with an apex angle of about 90 degrees and a height of about 30 μm and being formed of an acrylic resin was only used as a blank. A surface protective film was not used. It was evaluated whether curling of the prism base sheet was generated or not.

### Evaluation Method

### Size Change Ratio

A square of 220 mm×220 mm was cut out from each sample. A 200-mm long linear line was drawn on the square in each of MD (the machine direction) and TD (the traverse direction) to mark a cross. A length (mm) of the mark was measured before and after heating (90 degrees C., 60 minutes) by a glass scale (manufacture by TOKAI SANGYO CO., LTD.). A size change ratio was calculated by assigning the measured length in the following formula (I). The size change ratio was evaluated and marked with “+” for expansion and “−” for shrinkage.

The results of the evaluation are shown in Table 1.

Formula of Size Change Ratio

size change ratio (%)={(size after heating−size before heating)/size after heating}×100 (1)

### Curling Property

Under a linear pressure of 0.38 MPa at 2 m/min, each sample (Examples 1-3, Comparatives 1-6) was attached by pressure to an acrylic resin-made prism base sheet having a triangular cross-section with an apex angle of about 90 degrees and a height of about 30 μm (the same prism base sheet as the blank of Comparative 7), from which a square of 220 mm×220 mm was cut out. The square was heated at 50 degrees C. for 24 hours and then visually checked whether curling was generated or not. The sample of Comparative 7 was heated in the same manner as other samples and then was visually checked whether curling was generated or not.

The results of the evaluation are shown in Table 1.

TABLE 1

| | Size Change Ratio (%) | | Generation |
|---|---|---|---|
| | MD | TD | of Curling |
| Example 1 | −0.08 | +0.05 | No |
| Example 2 | −0.02 | +0.10 | No |
| Example 3 | −0.15 | +0.05 | No |
| Comparative 1 | −0.80 | +0.30 | Yes |
| Comparative 2 | −0.64 | +0.16 | Yes |
| Comparative 3 | −0.75 | +0.30 | Yes |
| Comparative 4 | — | — | — |
| Comparative 5 | −0.65 | +0.25 | Yes |
| Comparative 6 | −0.60 | +0.30 | Yes |
| Comparative 7 | — | — | No |

### Results

From the results shown in Table 1, it is understood that, even in the surface protective film using BPP (polypropylene) as the base layer, the aforementioned predetermined thermal treatment can reduce the size change ratio of the surface protective film to prevent generation of curling.

In Comparative 4, since the thermal treatment was conducted at a temperature near the melting point of BPP used in the base layer, appearance was deteriorated, so that a favorable sample was not obtained.

### INDUSTRIAL APPLICABILITY

The invention is usable as a suitable surface protective film including a base layer and an adhesion layer for a target member, particularly one such as a prism sheet having a projection on its surface. The invention is also usable as a base film that is the base layer of the surface protective film.

1. A method for manufacturing a surface protective film comprising a base layer and an adhesion layer, the method comprising:
using polypropylene as a main component for the base layer; and
before or after the adhesion layer is laminated on the base layer, thermally treating the surface protective film at a temperature from 40 degrees C. to 100 degrees C. for 1 second to 120 seconds such that a size change ratio at which the surface protective film changes in size after being heated at 90 degrees C. for one hour falls within ±0.50% in each of MD (a machine direction) and TD (a traverse direction).

2. A surface protective film comprising a base layer and an adhesion layer, wherein
the base layer contains polypropylene as a main component, and
a size change ratio at which the surface protective film changes in size after being heated at 90 degrees C. for one hour falls within ±0.50% in each of MD (a machine direction) and TD (a traverse direction).

3. The surface protective film according to claim 2, wherein
the base layer is thermally treated at a temperature from 40 degrees C. to 100 degrees C. for 1 second to 120 seconds before or after the adhesion layer is laminated on the base layer.

4. A method for manufacturing a base film for a surface protective film, comprising:
using polypropylene as a main component; and
thermally treating the base film for the surface protective film at a temperature from 40 degrees C. to 100 degrees C. for 1 second to 120 seconds such that a size change ratio at which the surface protective film changes in size after being heated at 90 degrees C. for one hour falls within ±0.50% in each of MD (a machine direction) and TD (a traverse direction).

5. A base film for a surface protective film on which an adhesion layer is laminated, the base film and the adhesion layer being adhered to a target member, wherein
the base film has polypropylene as a main component,
the base film is thermally treated at a temperature from 40 degrees C. to 100 degrees C. for 1 second to 120 seconds, and
a size change ratio at which the base film changes in size after being heated at 90 degrees C. for one hour falls within ±0.50% in each of MD (a machine direction) and TD (a traverse direction).
